(19) United States
(12) Patent Application Publication
(10) Pub. No.: US 2006/0274396 A1
(43) Pub. Date: Dec. 7, 2006

(54) Optical arrangement with oscillating reflector

(75) Inventors: Willem Lubertus Ijzerman, Eindhoven (NL); Oscar Hendrikus Willemsen, Den Bosch (NP); Teunis Willem Tukker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/571,712

(22) PCT Filed: Sep. 27, 2004
(86) PCT No.: PCT/IB04/51873

§ 371 Date: Mar. 10, 2006

Related U.S. Application Data
(60) Provisional application No. 60/507,325, filed on Sep. 30, 2003.

(51) Int. Cl. G02B 26/08

(52) U.S. Cl. 359/224

(57) ABSTRACT

An optical system includes a light source that outputs light that is incident on an oscillating reflector. The optical system includes at least one lens element, which outputs the light in a collimated beam on the oscillating reflector regardless of an orientation of the oscillating reflector. The optical system may be used in laser displays in general, and in small feature laser displays.

Scanning of an optical beam has a variety of applications. For example, bar code readers often use the output light of a laser or light emitting diode to scan a bar code. These devices also include a reflective element, such as a mirror, which reflects the incident light from the light source, and project the scanned image. Moreover, the mirror oscillates, and depending on its orientation during the oscillation, the mirror will reflect the light in different directions. As is well known, these devices may be used in laser displays, which use a modulated laser beam on a scanning mirror/rotating polygon to generate an image. These devices may be used in consumer devices, with the image being projected in a relatively small format. Often it is desired to provide a projector including an oscillating mirror, which reflects light from a source in a small package, such as a mobile scanning device. In these applications, it is advantageous to have the reflective element oscillate at relatively high frequencies, providing a desired relatively high scan rate.

Unfortunately, known devices are relatively large and the balancing of the mirror should be done very carefully, making the device very expensive. In addition, a fast rotating device is very difficult to combine with a mobile applications, since changing its direction would be very difficult. Finally, the device is inherently noisy, which makes it inappropriate for domestic use.

Additionally, using known optical scanning devices, the scanning angle may deteriorate causing a distortion of the projected light from the laser. To this end, a known device includes a laser positioned so that its diverging beam is incident on a very small scanning mirror (for instance a cantilever). In order to focus the reflected diverging beam, a positive lens is disposed between the mirror and the projection surface. The disadvantage of this setup is that the positive lens decreases the scanning angle of the beam, thus generating a smaller image at a given projection distance. Moreover, because of the relatively small diameter of the scanning mirror, the beam diameter should be even smaller. Such a small beam diameter automatically gives rise to diffraction effects, which becomes evident as a diverging beam. This ultimately fosters a distorted image at the projection surface Furthermore, as the diameter of the beam approaches to the width of the mirror, the diffraction effects will be enlarged. Both sources of diffraction result in reduced efficiency and distortion of the projected image from the laser.

Accordingly, what is needed is an optical system that overcomes at least the drawbacks of the structure referenced above.

Accordingly, in accordance with an example embodiment an optical system includes a light source that outputs light that is incident on an oscillating reflector. The optical system includes at least one lens element, which outputs the light in a collimated beam on the oscillating reflector regardless of an orientation of the oscillating reflector.

The invention is best understood from the following detailed description when read with the accompanying drawing figures. It is emphasized that the various features are not necessarily drawn to scale. In fact, the dimensions may be arbitrarily increased or decreased for clarity of discussion.

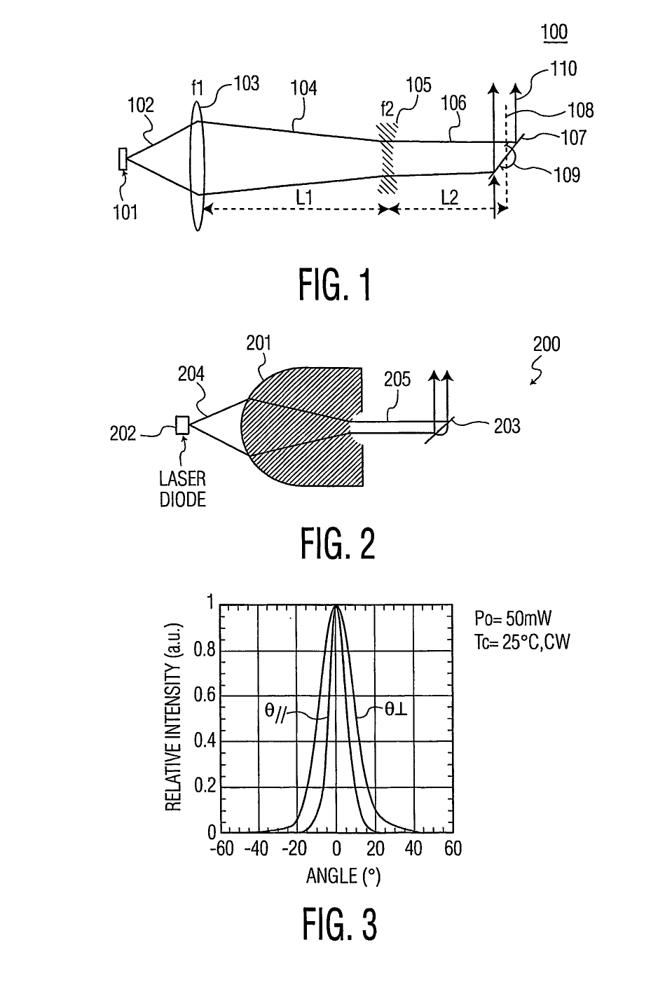

FIG. 1 is a perspective view of an optical system in accordance with an example embodiment.

FIG. 2 is a perspective view of an optical system in accordance with an example embodiment.

FIG. 3 is a graphical representation of the relative intensity versus the far field angle of a laser in accordance with an example embodiment.

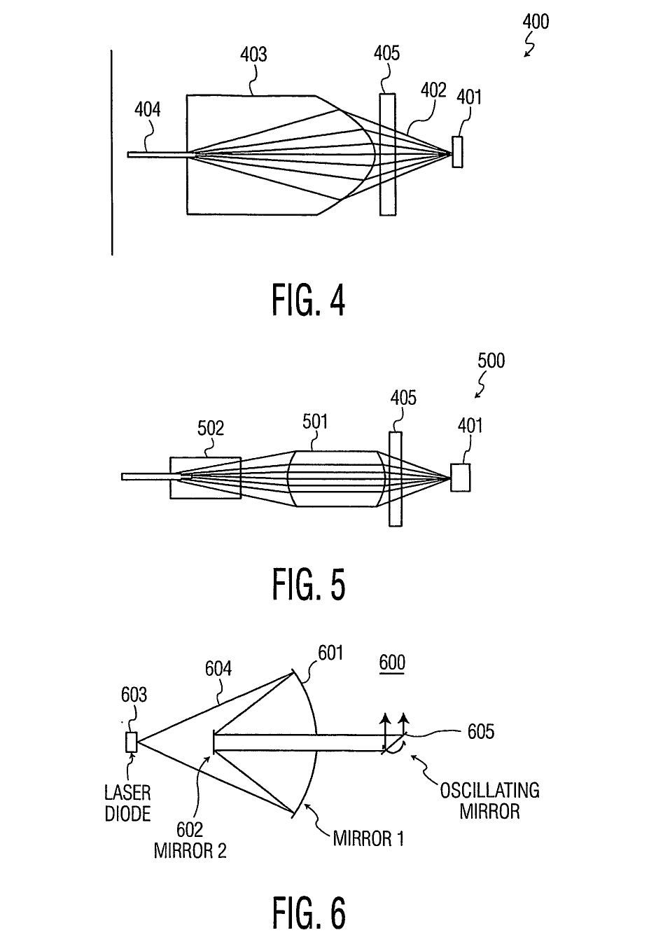

FIG. 4 is a perspective view of an optical system in accordance with an example embodiment.

FIG. 5 is a perspective view of an optical system in accordance with an example embodiment.

FIG. 6 is a perspective view of an optical system in accordance with an example embodiment.

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

In accordance with an example embodiment, an optical system provides a light source that forms a spot on the cantilever scanner, and the optical system focuses the spot at infinity. An illustrative optical system 100 is shown in FIG. 1. The optical system 100 includes a light source 101, which is illustratively a semiconductor laser, such as a laser diode. Light 102 emitted from the light source is emitted at a known angular spread from the light source 101, and is incident on a first lens element 103. This first lens element 103 is a positive lens element, which focuses the light 104 at a certain finite image point. The first lens element 103 is illustratively a known positive power lens element well within the purview of one of ordinary skill in the art. For example, first lens element 103 may be a geometric lens, a holographic optical element or a graded refractive index (GRIN) lens.

After the first lens element 103, but before the image point of the first lens element 103, a second lens element 105 is located. The second lens element 105 is a negative lens that is positioned with its focal point at the image point of the first lens and thus focuses the light at infinity. Light 106 thus emerges from the second lens element 105 as a parallel beam, which is incident on the reflective element 107.

The reflective element 107 is illustratively an optical grade mirror, but could be another type of reflective element within the purview of the artisan of ordinary skill in the optical arts. The reflective element 107 oscillates in a rotational manner and over a predetermined arc length about an axis 108. An illustrative rotation is shown at 109. The reflective element provides the scanning capability of the optical system 100, and may be used to provide a scanned optical image of the light 102, which emerges from the optical system 100 as reflected light 110. Illustratively, such devices scan a light beam at high repetition rate.

As mentioned above, scanning devices are used for a diversity of applications, such as bar-code readers, illumination systems and laser printers. Although these applications may be used with scanners that are operated in the regime of approximately 1 kHz to approximately 10 kHz, the ever increasing demand for faster applications causes the known scanners to be lacking. For example, the laser display, especially when it is operated at a resolution that exceeds the VGA format, needs a scanner that can be operated at approximately 16 kHz or higher.

The optical system 100 provides certain benefits compared to known optical scanning arrangements. First, because the light 106 is collimated, it is reflected in a substantially collimated manner. In contrast, known optical systems result in the light reflected from the oscillating mirror being diverging in nature. Unfortunately, this diverging beam results in a loss of resolution. Accordingly, one clear benefit of the optical system 100 is an improved beam resolution.

It is noted that the example embodiment of FIG. 1 includes a positive lens and a negative lens. This arrangement is merely illustrative, and other optical systems including, but not limited to, those described in connection with other illustrative embodiments may be used to form a collimated beam incident on and reflected from the oscillating reflector. For example, two positive lenses could be placed between the light source 101 and the oscillating reflector 107. In this case the image point of the first positive lens (closest to the light source 101) and the back focal point of the second positive lens (closest to the reflector 107) are coincident. This results in the collimation of the light, which when incident on the reflector is reflected as a collimated beam, as desired.

An optical system 200 in accordance with an exemplary embodiment is shown in FIG. 2. The optical system 200 is substantially identical in function to the optical system 100 of FIG. 1. However, as is quite evident, the optical system 200 includes only one optical element 201 between a light source 202 and an oscillating reflector 203. The optical element 201 is essentially a lens element that integrates a positive and negative lens so that the light 204, which diverges from the source 202, outputs a collimated beam 205, which is incident on the oscillator reflector 203. As described above, the output from the reflector is also collimated, which is clearly beneficial at the imaging surface.

In accordance with an example embodiment, an optical system such as optical system 200 has a numerical aperture of approximately 0.4. In such a system, light from the light source (e.g., diverging beam 204) of the optical system within an opening angle of 23.5° is captured in the optical system. An example of the light output of a laser diode light source is shown in FIG. 3. The far field patterns of the laser diode are shown graphically with the relative intensity along the ordinate and the angle along the abscissa. As can be readily appreciated, the majority of light output is within the opening angle specified.

In accordance with another example embodiment shown in FIG. 4, an optical system includes a light source 401, which outputs a diverging beam 402. This beam is incident on a window 405 of the packaged light source, and on a lens element 403. The light output 404 of the lens element 403 is a parallel beam (collimated). In an example embodiment, light from the source has a wavelength of 660 μm and the total length of the system is 3.12 mm. The light output 404 that is aimed at the oscillating cantilever reflector (not shown) of a scanning system has a diameter of 100 μm. This embodiment functions in a similar fashion to the example embodiments thus described.

In accordance with another example embodiment shown in FIG. 5, an optical system 500 includes two lens elements. This system has a total length of 4:43 mm. Because the curvature of the lens surfaces is smaller the design of anti-refection coatings is less difficult. It is noted that the system of FIG. 5 includes many similar features and elements of the system of FIG. 4. Commonalities are omitted in the interest of clarity.

FIG. 6 shows an optical system 600 in accordance with another example embodiment. In this example embodiment, the numerical aperture of the optical system 600 may be improved by using a Schwartzschild mirror as shown in FIG. 6. The optical system 600 includes a first mirror 601 and a second mirror 602 to focus the output diverging light 604 from the light source 603, which is illustratively a laser diode. The numerical aperture of the system 600 is determined mainly by the size of the first mirror 601. The optical system of the example embodiment is beneficial because it allows the focusing of the light output 604 to relatively small diameters since only little light is blocked by the second mirror 602. To this end, it is beneficial to reduce the spot size of the light incident on the oscillator reflector 605, so that its is substantially less than the area/size of the reflector 605 in order to optimize the amount of light that is actually reflected, as well as to reduce the effects of diffraction. For example, from a review of FIG. 3, the tails of the Gaussian beam may be outside the capture angle of the mirror, resulting in lost intensity. This, couple with losses due to diffraction at the reflector 605 can reduce the intensity of the output light at the image plan/screen to an unacceptable level.

For the purpose of illustration of the effects of diffraction, consider the intensity as a function of the radius, r:
I=Iₒexp (−2r²/wₒ²)

where w₀ is the beam diameter.

As is well known, the beam will spread due to the effects of diffraction, particularly due to diffractive effects of reflection at the oscillating reflectors of the illustrative optical systems. Moreover, as it is desired to have a relatively small cantilevered oscillating reflector, there is the possibility that the beam spot size incident on the reflector is nearly the same size as the reflector. This results in the tails of the Gaussian light distribution being outside the width of the reflector, and the loss of intensity of the reflected beam. As such, it is beneficial to relatively reduce the spot size of the beam incident on the reflective compared to the size of the reflector, and to reduce the effects of diffraction.

For the purposes of illustration, for light having a wavelength (λ) of 0.6 μm with a beam diameter w₀ of 100 μm, the angular spread is approximately 4 mrad. As such, if the image plane/screen is at a distance of 0.5 m, the spot size is increased to 2 mm due to diffraction. Increasing the beam diameter to 200 μm, increases the spot size to approximately 1 mm, which is quite acceptable for mobile optical scanners. Beneficially, the example embodiments limit the beam divergence to the value that can be expected from diffraction.

In accordance with example embodiments described above, optical systems adapted for use in a laser projector in which the scanner is based on an oscillating cantilever are disclosed. The optical system may include a scanner that can reach high frequencies and large scanning angles. However, the reflecting surface is very small, typically 100 μm by 100 μm. The optical systems focus the light output from the optical source at infinity, i.e. is a parallel beam. This implies that no additional elements besides those described above are necessary to focus the beam. The illustrative optical systems are able to create a parallel light beam with a cross-section of approximately 100 μm on the oscillating cantilever reflector, while requiring no lens action behind the cantilever. Consequently, the optical systems of the example embodiments do not deteriorate the scanning angle. In practice a mirror of a 100 μm diameter will result in a beam that has a large angular spread due to diffraction. Therefore, a mirror of a diameter of approximately 200 μm is more useful.

The example embodiments having been described in detail in connection through a discussion of exemplary embodiments, it is clear that modifications of the invention will be apparent to one having ordinary skill in the art having had the benefit of the present disclosure. Such modifications and variations are included in the scope of the appended claims.

1. An optical system comprising:
a light source that outputs light that is incident on an oscillating reflector, wherein the optical system includes at least one lens element, which outputs the light in a collimated beam on the oscillating reflector regardless of an orientation of the oscillating reflector.

2. An optical system as recited in claim 1, wherein the optical source is a laser.

3. An optical system as recited in claim 1, wherein the optical system includes a positive lens element and a negative lens element.

4. An optical system as recited in claim 1, wherein the oscillating reflector is a cantilevered mirror.

5. An optical system as recited in claim 1, wherein the oscillating reflector oscillates at frequency of at least 16 kHz.

6. An optical system as recited in claim 1, wherein the at least one lens element is an integrated lens element, which includes a positive lens and a negative lens.

7. An optical system as recited in claim 1, wherein the optical system includes two positive lenses, and the image point of the first lens is at the focal point of the second lens.

8. An optical system as recited in claim 1, wherein the optical system is included in a laser display device.

9. An optical system, comprising:
a light source that outputs light that is incident on an oscillating reflector, wherein the optical system includes a first mirror, and a second mirror, wherein the first and second mirrors combined output the light in a collimated beam on the oscillating reflector regardless of an orientation of the oscillating reflector.

10. An optical system as recited in claim 8, wherein the optical source is a laser.

11. An optical system as recited in claim 8, wherein the optical system is included in a laser display device.

12. An optical system as recited in claim 11, wherein the oscillating reflector is a cantilevered mirror.

13. An optical system as recited in claim 1, wherein the oscillating reflector oscillates at frequency of at least 16 kHz.

14. An optical system as recited in claim 8, wherein the first and second mirrors comprise Schwartzschild mirror.
